(19) United States
(12) Patent Application Publication
(10) Pub. No.: US 2025/0108458 A1
(43) Pub. Date: Apr. 3, 2025

(54) INGOT SPLITTING METHOD AND INGOT SPLITTING APPARATUS

(71) Applicant: Industrial Technology Research Institute, Hsinchu (TW)

(72) Inventors: Kun-Wei Lin, Tainan City (TW); Tung-Ying Lin, Kaohsiung City (TW); Miao-Chang Wu, Tainan City (TW)

(73) Assignee: Industrial Technology Research Institute, Hsinchu (TW)

(21) Appl. No.: 18/827,875

(22) Filed: Sep. 9, 2024

(30) Foreign Application Priority Data
Oct. 3, 2023 (TW) 112137962

(51) Int. Cl. B23K 26/38; B23K 26/082; B23K 26/70; B23K 37/04

(52) U.S. Cl. CPC B23K 26/38; B23K 26/082; B23K 26/702; B23K 37/0426

(57) ABSTRACT

An ingot splitting method and an ingot splitting apparatus are provided. The ingot splitting method includes the following steps. A laser provided from a laser source is focused with a focusing lens group on a plane to be split of an ingot, and a focus point of the laser is used to scan the plane to be split. An opposing first side and second side of the ingot are fixed with a chuck table and an ultrasonic source. The plane to be split is located between the first side and the second side. A pulling force is applied to the second side in a direction away from the ingot with a tensioner, and ultrasonic waves are applied to vibrate the ingot with the ultrasonic source simultaneously, so that the ingot is divided into two parts from the plane to be split.

### CROSS-REFERENCE TO RELATED APPLICATION

This application claims the priority benefit of Taiwan application serial no. 112137962, filed on Oct. 3, 2023. The entirety of the above-mentioned patent application is hereby incorporated by reference herein and made a part of this specification.

### TECHNICAL FIELD

The disclosure relates to a splitting method and a splitting apparatus, and particularly relates to an ingot splitting method and an ingot splitting apparatus.

### BACKGROUND

Along with ccontinuous advancement of science and technology, semiconductor materials are widely used in various electronic products. In order to manufacture semiconductor components, after an ingot is manufactured, it must first be split to form sheet-shaped wafers. The existing ingot splitting method usually uses a diamond wire saw as a tool. However, a width of the diamond wire saw itself causes a huge proportion of kerf loss during the splitting process. In addition, the loss during wafer polishing after splitting results in a high proportion of overall material loss. For example, in the case where a thickness of a target wafer is 350 μm, 260 μm of kerf loss and grinding and polishing loss are generated simultaneously for each wafer produced. Therefore, how to reduce the proportion of material loss during the ingot splitting process has become an urgent issue to be solved.

### SUMMARY

The disclosure is directed to an ingot splitting method and an ingot splitting apparatus, which are adapted to mitigate a phenomenon in which the proportion of material loss is excessive during an ingot splitting process.

The ingot splitting method of the disclosure performed by an ingot splitting apparatus which includes a chuck table, an ultrasonic source and a tensioner, includes following steps. A laser provided from a laser source is focused with a focusing lens group on a plane to be split of an ingot, and a focus point of the laser is used to scan the plane to be split. An opposing first side and second side of the ingot are fixed with the chuck table and the ultrasonic source. The plane to be split is located between the first side and the second side. A pulling force is applied to the second side in a direction away from the ingot with the tensioner, and ultrasonic waves are applied with the ultrasonic source to vibrate the ingot simultaneously, so that the ingot is divided into two parts from the plane to be split.

The ingot splitting apparatus of the disclosure is configured to split an ingot. There is a plane to be split inside the ingot. The ingot splitting apparatus includes a chuck table, an ultrasonic source, and a tensioner. The chuck table is configured to be fixedly connected to a first side of the ingot. The ultrasonic source is configured to be fixedly connected to a second side opposite to the first side of the ingot. The tensioner is configured to be fixedly connected to the ultrasonic source. The tensioner applies a pulling force to the second side in a direction away from the ingot, and the ultrasonic source applies ultrasonic waves to vibrate the ingot simultaneously, so that the ingot is divided into two parts from the plane to be split.

Through the ingot splitting method and the ingot splitting apparatus of the disclosure, laser scanning is used and ultrasonic waves are applied simultaneously to vibrate the ingot for splitting, which may reduce material loss.

### BRIEF DESCRIPTION OF THE DRAWINGS

FIG. 1 is a schematic view of a laser scanner of an ingot splitting apparatus performing laser scanning according to an embodiment of the disclosure.

FIG. 2 is a schematic view of a step of applying a pulling force in the ingot splitting method performed by the ingot splitting apparatus of FIG. 1.

FIG. 3 and FIG. 4 are schematic views of a step of applying a pulling force in the ingot splitting method according to two other embodiments of the disclosure.

FIG. 5 is a schematic view of an ultrasonic source and a tensioner in an ingot splitting apparatus according to yet another embodiment of the disclosure.

FIG. 6 is a three-dimensional view of the ultrasonic source in FIG. 5.

FIG. 7 is a schematic view of an end surface of an ultrasonic source in the ingot splitting apparatus according to still another embodiment of the disclosure.

FIG. 8 and FIG. 9 are schematic views of an end surface of an ultrasonic source in the ingot splitting apparatus used to contact ingots of different sizes according to another embodiment of the disclosure.

### DETAILED DESCRIPTION OF DISCLOSED EMBODIMENTS

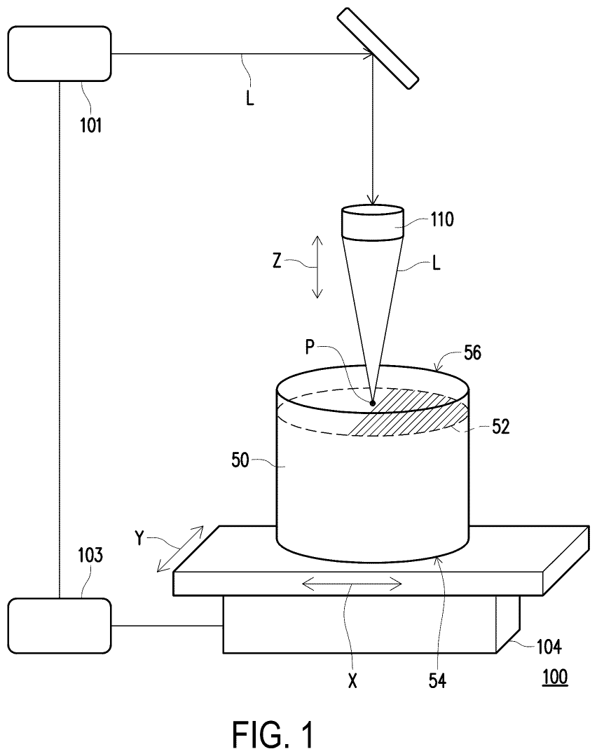

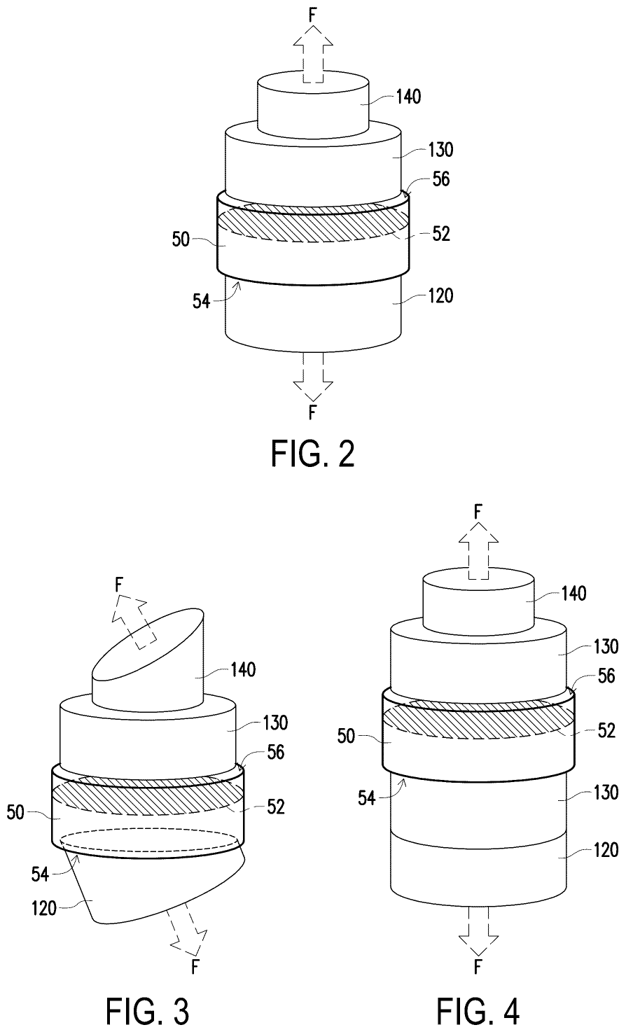

FIG. 1 is a schematic view of a laser scanner of an ingot splitting apparatus performing laser scanning according to an embodiment of the disclosure. Referring to FIG. 1 and FIG. 2, the ingot splitting apparatus of the embodiment includes a chuck table 120, an ultrasonic source 130, and a tensioner 140. The ingot splitting apparatus of the embodiment is configured to split an ingot 50. The ingot splitting method of the embodiment is implemented by a laser scanner 100, which may include a laser source 101, a focusing lens group 110, a control unit 103, and a precision moving platform 104. The ingot splitting method of the embodiment, for example is a series of control instructions stored in and executed by the control unit 103 and the control unit 103 can be a computer, the ingot splitting method includes following steps. First, after the ingot 50 is fixed on the precision moving platform 104 by a user, a laser beam L is focused on a plane to be split 52 inside the ingot 50, and a focus point P of the laser beam L is used to scan the plane to be split 52.

In the embodiment, the control unit 103 drives the laser source 101 to generate the laser beam L. Through the adjustment of the focusing lens group 110 in a Z direction (an up-down direction), the focus point P of the laser beam L is located at a fixed depth from the surface 56 of the ingot 50, for example, at a place where the plane to be split 52 is located. The focusing lens group 110 is used together with the laser beam L, and the control unit 103 drives the precision moving platform 104 to position a processing position. The focus point P of the focused laser beam L is scanned in a Y direction within the ingot 50, so that a modified path is formed at the location of the plane to be split 52 inside the ingot 50 and a modified crack that grows in both directions is generated. Then, in collaboration with a feeding mechanism of the precision moving platform 104 in an X direction, modified paths and modified cracks are formed and interconnected with previous modified paths and modified cracks, and the entire plane to be split 52 is sequentially scanned.

The above-mentioned ingot splitting method and ingot splitting apparatus of the various embodiments of the present disclosure may be used for silicon carbide (SiC) ingots, but the disclosure is not limited thereto. When the focus point P of the laser beam L is focused on the inside of the ingot 50, the material at the focus point P may decompose into amorphous silicon and carbon after absorbing the laser energy, causing crystal lattice of the ingot 50 at the focus point to expand to form cracks. Therefore, after the focus point P of the laser beam L scans across the plane to be split 52, a structural strength of the ingot 50 at the plane to be split 52 may be greatly weakened.

FIG. 2 is a schematic view of a step of applying a pulling force in the ingot splitting method performed by the ingot splitting apparatus. Referring to FIG. 2, an opposing first side 54 and second side 56 of the ingot 50 are fixed with the chuck table 120 and the ultrasonic source 130. The plane to be split 52 is located between the first side 54 and the second side 56. The chuck table 120 is fixedly connected to the first side 54 of the ingot 50. The ultrasonic source 130 is fixedly connected to the second side 56 of the ingot 50 opposite to the first side 54.

Then, the tensioner 140 is connected to the ultrasonic source 130, and is driven by the control unit 103 to apply a pulling force F to the second side 56 in a direction away from the ingot 50, and the ultrasonic source 130 is also driven by the control unit 103 to apply ultrasonic waves to vibrate the ingot 50 simultaneously, so that the ingot 50 is split into two parts from the plane to be split 52. The tensioner 140 exerts the pulling force F on the second side 56 through the ultrasonic source 130, and the ultrasonic source 130 applies ultrasonic waves to vibrate the ingot 50 simultaneously. Since the structural strength of the ingot 50 at the plane to be split 52 has been greatly weakened, when the pulling force F is applied to the ingot 50, the ingot 50 may be divided from the plane to be split 52. However, in the embodiment, since when the pulling force F is applied to the ingot 50, ultrasonic waves are also applied to vibrate the ingot 50 simultaneously, the ultrasonic vibration may accelerate the growth of cracks and connect adjacent cracks together, so that the ingot 50 may be divided from the plane to be split 52 more quickly with less effort, thereby forming a desired wafer. Moreover, the pulling force F and ultrasonic vibration applied at the same time may produce a complementary superimposed effect.

Since a size of the focus point P of the laser beam L is very small, for example, less than 5 μm, a thickness of material loss caused by the laser beam L is much smaller than a thickness of material loss caused by using a diamond wire saw. In this way, the number of wafers that may be produced from a single ingot 50 may be greatly increased, which may not only reduce a material cost of the wafers, but also increase a production speed of the wafers.

In the embodiment, the force applying direction of the pulling force F exerted by the tensioner 40 is perpendicular to the plane to be split 52, but the disclosure is not limited thereto.

In the embodiment, before the ingot 50 is split into two parts from the plane to be split 52, the maximum pulling force per unit area exerted by the tensioner 140 on the ingot 50 is less than 0.06 MPa, but the disclosure is not limited thereto.

In the embodiment, a frequency of the ultrasonic waves applied by the ultrasonic source 130 is 20 KHz to 30 KHz, such as 20 KHz, 28 KHz, or 30 KHz, but the disclosure is not limited thereto.

In the embodiment, the ingot 50 is adhered or sucked to the chuck table 120, i.e., the ingot 50 may be adhered to the chuck table 120 by using an adhesive material, or the ingot 50 may be sucked to the chuck table 120 by using a suction chuck. On the other hand, in the embodiment, the ultrasonic source 130 is adhered or sucked to the ingot 50, i.e., the ultrasonic source 130 may be adhered to the ingot 50 by using an adhesive material, or the ultrasonic source 130 may be sucked to the ingot 50 by vacuum suction. Since the pulling force required by the ingot splitting method of the embodiment is very small, and may even be less than a force of vacuum suction, the crystal ingot 50 may be fixed by vacuum suction, making it easier to automatize the ingot splitting apparatus.

FIG. 3 and FIG. 4 are schematic views of a step of applying a pulling force in the ingot splitting method according to two other embodiments of the disclosure. Referring to FIG. 3 first, the ingot splitting method and the ingot splitting apparatus in the embodiment are similar to that in the embodiment in FIG. 1 and FIG. 2, and a difference is that the force applying direction of the pulling force F exerted by the tensioner 140 is not perpendicular to the plane to be split 52. However, the ingot splitting method and the ingot splitting apparatus in the embodiment may still quickly and more effortlessly separate the ingot 50 from the plane to be split 52, which may reduce the material cost of the wafers and may also increase a throughput of the wafers.

Referring to FIG. 4, the ingot splitting method and ingot splitting apparatus in the embodiment are similar to that of the embodiment in FIG. 1 and FIG. 2, and a difference is that one ultrasonic source 130 is respectively fixed at two ends of the ingot 50. The chuck table 120 is fixedly connected to the ultrasonic source 130 on the first side 54, and the tensioner 140 is fixedly connected to the ultrasonic source 130 on the second side 56. The tensioner 140 exerts the pulling force F on the ingot 50, and the ultrasonic source 130 vibrates the ingot 50 with ultrasonic waves simultaneously to perform splitting.

Taking a thickness of a target wafer of 350 μm as an example, by using the above-mentioned ingot splitting method and the ingot splitting apparatus of various embodiments of the disclosure, only 80 μm of kerf loss and grinding and polishing loss are generated for each wafer produced, which is much lower than the loss generated when using a diamond wire saw.

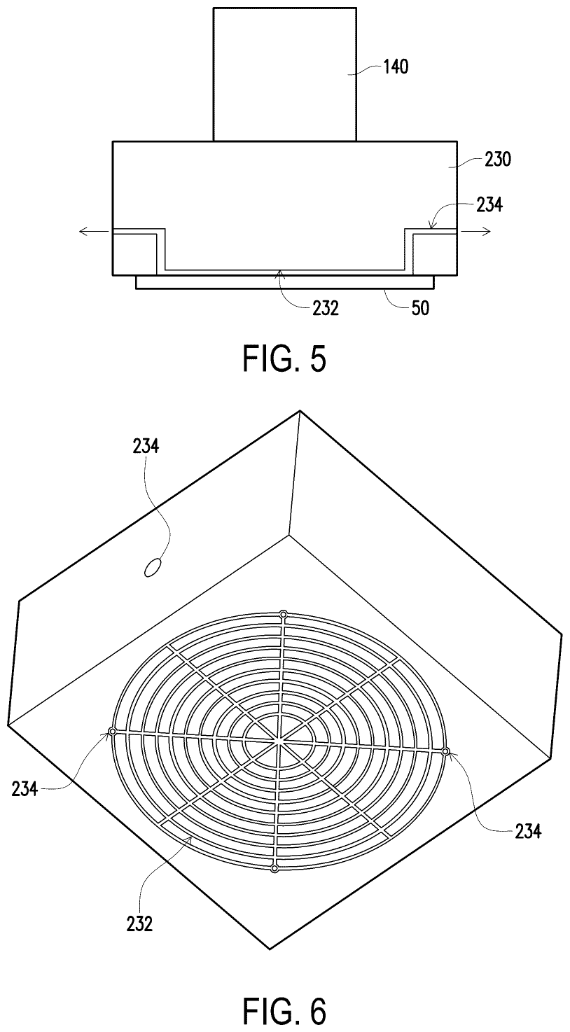

FIG. 5 is a schematic view of an ultrasonic source and a tensioner in an ingot splitting apparatus according to yet another embodiment of the disclosure. FIG. 6 is a three-dimensional view of the ultrasonic source in FIG. 5. Referring to FIG. 5 and FIG. 6, when an ultrasonic source 230 is fixedly connected to the ingot 50 by vacuum suction, an air extraction groove 232 may be provided on an end surface of the ultrasonic source 230 for contacting the ingot 50. The air extraction groove 232 may be connected to a vacuum system (not shown). When the end surface of the ultrasonic source 230 is in contact with the ingot 50, the air in the air extraction groove 232 is extracted by the vacuum system to create a negative pressure environment, so that the ingot 50 may be sucked on the end surface of the ultrasonic source 230. In the embodiment, the ultrasonic source 230 is, for example, a cube, but the ultrasonic source 230 may also be a cylinder or other shapes, which is not limited by the disclosure. In addition, the ultrasonic source 230 may further include an air extraction channel 234. The air extraction channel 234 is configured to connect with the air extraction groove 232 and the vacuum system. A number of the air extraction channels 234 may be one or more, or a single air extraction channel 234 may have multiple branches, and the type of the air extraction channel 234 is not limited by the disclosure.

In addition, the end surface of the chuck table in the disclosure for contacting the ingot or the ultrasonic source may also have an air extraction groove as described above, so that the chuck table may be fixedly connected to the ingot by vacuum suction.

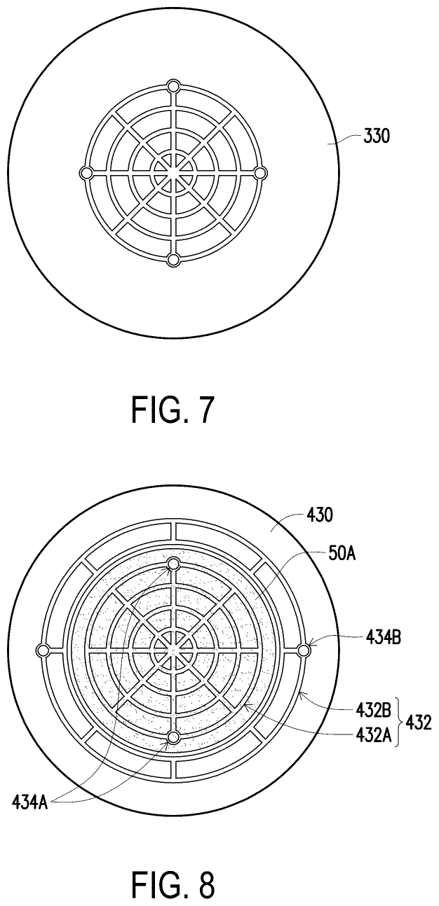

FIG. 7 is a schematic view of an end surface of an ultrasonic source in the ingot splitting apparatus according to still another embodiment of the disclosure. Referring to FIG. 7, an end surface of an ultrasonic source 330 of the embodiment is circular.

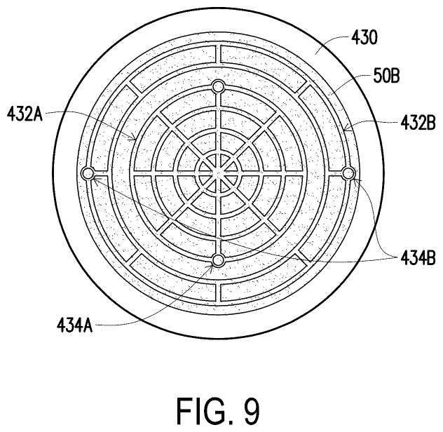

FIG. 8 and FIG. 9 are schematic views of an end surface of an ultrasonic source in the ingot splitting apparatus used to contact ingots of different sizes according to another embodiment of the disclosure. Referring to FIG. 8 and FIG. 9, an air extraction groove 432 on an end surface of an ultrasonic source 430 of the embodiment is divided into two parts, which are respectively an air extraction groove 432A located in the interior and an air extraction groove 432B located in the periphery. As the sizes of the ingots may be different, the air extraction groove 432 may be divided into multiple parts. The air extraction groove 432A located in the interior may correspond to a smaller ingot 50A, and the air extraction groove 432A located in the interior and the air extraction groove 432B located in the periphery may combine together to correspond to a larger ingot 50B. Therefore, the ultrasonic source 430 of the embodiment may correspond to ingots of various sizes. In addition, the air extraction groove 432A and the air extraction groove 432B may respectively correspond to different air extraction channels 434A and 434B. When the ultrasonic source 430 is used for vacuum suction of the smaller ingot 50A, air extraction of the air extraction groove 432A is implemented only through the air extraction channel 434A. When the ultrasonic source 430 is used for vacuum suction of the larger ingot 50B, air extraction of the air extraction groove 432A and the air extraction groove 432B is implemented through the air extraction channel 434A and the air extraction channel 434B.

In order to verify the above-mentioned effect of the ingot splitting method and the ingot splitting apparatus of the various embodiments of the disclosure, the applicant uses a 1 cm square silicon carbide block with a thickness of 360 μm as a sample. After using the focus point of the laser to scan the plane to be split, a pulling force is directly applied but ultrasonic vibration is not applied to perform splitting, and a pulling force per unit area of approximately 3 MPa to 20 MPa is required to complete the splitting.

When instead ultrasonic vibration with a frequency of 28 KHz and a power of 20 W is applied for 20 minutes first, and then the pulling force is applied for splitting, the pulling force per unit area of approximately 7 MPa is still required to complete the splitting. Moreover, during the early application of ultrasonic vibration, it is easy for the silicon carbide block to produce fragments.

However, when the ingot splitting method and the ingot splitting apparatus of the various embodiments of the disclosure are used, i.e., after the focus point of the laser is used to scan the plane to be split, the pulling force and ultrasonic vibration are simultaneously applied to perform splitting, now only a pulling force per unit area of about 0.02 MPa is required to complete the splitting within 10 seconds. The frequency of the used ultrasonic vibration is, for example, 28 KHz, the power is 20 W, and a direction of the pulling force is perpendicular to the plane to be split.

In another experiment, the applicant uses a 1 cm square silicon carbide block with a thickness of 1 mm as a sample. The frequency of the used ultrasonic vibration is also 28 KHz and the power is 20 W, and it still only requires a pulling force per unit area of about 0.06 MPa to complete the splitting within 10 seconds. In the aforementioned experiment, the pulling force perpendicular to the plane to be split is used. However, even if the direction of the pulling force is modified to have an included angle of 30 degrees, 45 degrees, or 60 degrees with the plane to be split, as long as the pulling force and the ultrasonic vibration are applied simultaneously, a pulling force per unit area of approximately 0.06 MPa will be required to complete the splitting within 10 seconds. At the same time, it may also be observed that the more the direction of the pulling force approaches to be parallel to the plane to be split, the larger the magnitude of the pulling force that needs to be applied, such that the direction of the pulling force preferably approaches to be perpendicular to the plane to be split.

In addition, it may also be observed from the experiment that compared with not applying pulling force and ultrasonic vibration simultaneously, if the pulling force and the ultrasonic vibration are applied simultaneously, the roughness of the splitting surface may be much reduced, and therefore the grinding and polishing loss may be reduced.

Therefore, the effect of the ingot splitting method and the ingot splitting apparatus of the disclosure is significantly better than the ingot splitting method in which only pulling force is applied but ultrasonic vibration is not applied simultaneously.

In summary, in the ingot splitting method and ingot splitting apparatus of the disclosure, after using laser to scan the ingot to form modified cracks, a pulling force is fixedly applied to the two ends and ultrasonic waves are applied simultaneously to vibrate the ingot for splitting, which may complete the splitting with a low proportion of material loss.

What is claimed is:

1. An ingot splitting method performed by an ingot splitting apparatus which includes a chuck table, an ultrasonic source and a tensioner, the ingot splitting method comprising the following steps of:
focusing a laser provided from a laser source with a focusing lens group on a plane to be split of an ingot, and using a focus point of the laser to scan the plane to be split;
fixing an opposing first side and a second side of the ingot with the chuck table and the ultrasonic source, wherein the plane to be split is located between the first side and the second side; and
applying a pulling force to the second side in a direction away from the ingot with the tensioner, and applying ultrasonic waves with the ultrasonic source to vibrate the ingot simultaneously, so that the ingot is divided into two parts from the plane to be split.

2. The ingot splitting method as claimed in claim 1, wherein a force applying direction of the pulling force is perpendicular to the plane to be split.

3. The ingot splitting method as claimed in claim 1, wherein a force applying direction of the pulling force is not perpendicular to the plane to be split.

4. The ingot splitting method as claimed in claim 1, wherein before the ingot is divided into two parts from the plane to be split, a maximum pulling force per unit area applied to the ingot is less than 0.06 MPa.

5. The ingot splitting method as claimed in claim 1, wherein a frequency of the applied ultrasonic waves is 20KHz to 30KHz.

6. The ingot splitting method as claimed in claim 1, wherein a frequency of the applied ultrasonic waves is 20 KHz, 28 KHz, or 30 KHz.

7. An ingot splitting apparatus, configured to split an ingot, wherein there is a plane to be split inside the ingot, the ingot splitting apparatus comprising:
a chuck table, configured to be fixedly connected to a first side of the ingot;
an ultrasonic source, configured to be fixedly connected to a second side opposite to the first side of the ingot; and
a tensioner, configured to be fixedly connected to the ultrasonic source, wherein the tensioner applies a pulling force to the ultrasonic source in a direction away from the ingot, and the ultrasonic source applies ultrasonic waves to vibrate the ingot simultaneously, so that the ingot is divided into two parts from the plane to be split.

8. The ingot splitting apparatus as claimed in claim 7, wherein a force applying direction of the pulling force applied by the tensioner is perpendicular to the plane to be split.

9. The ingot splitting apparatus as claimed in claim 7, wherein a force applying direction of the pulling force applied by the tensioner is not perpendicular to the plane to be split.

10. The ingot splitting apparatus as claimed in claim 7, wherein before the ingot is divided into two parts from the plane to be split, a maximum pulling force per unit area applied to the ingot by the tensioner is less than 0.06 MPa.

11. The ingot splitting apparatus as claimed in claim 7, wherein a frequency of the ultrasonic waves applied by the ultrasonic source is 20KHz to 30KHz.

12. The ingot splitting apparatus as claimed in claim 7, wherein a frequency of the ultrasonic waves applied by the ultrasonic source is 20 KHz, 28 KHz or 30 KHz.

13. The ingot splitting apparatus as claimed in claim 7, wherein the ultrasonic source is adhered or sucked to the ingot.

14. The ingot splitting apparatus as claimed in claim 13, wherein an air extraction groove is provided on an end surface of the ultrasonic source for being fixedly connected to the ingot.
